(19) United States
(12) Patent Application Publication
(10) Pub. No.: US 2009/0077582 A1
(43) Pub. Date: Mar. 19, 2009

(54) APPARATUS AND METHOD FOR STORING DIGITAL MULTIMEDIA BROADCASTING IN MOBILE TERMINAL

(75) Inventor: Jun-Sik Ahn, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/856,535

(22) Filed: Sep. 17, 2007

(30) Foreign Application Priority Data
Sep. 15, 2007 (KR) 2006-0089459

(51) Int. Cl. G06F 3/00; G06F 17/30

(52) U.S. Cl. 725/39; 707/3; 707/E17.014

(57) ABSTRACT

Provided is an apparatus and method for storing Digital Multimedia Broadcasting (DMB) in a mobile terminal. The method includes, upon receipt of a request for storing contents, searching received channel information for contents relation information that is relation information on the contents, and storing the contents and the searched contents relation information.

### PRIORITY

This application claims priority under 35 U.S.C. § 119 to an application filed in the Korean Intellectual Property Office on Sep. 15, 2006 and assigned Ser. No. 2006-89459, the contents of which are incorporated herein by reference.

### BACKGROUND OF THE INVENTION

1. Field of the Invention

The present invention relates generally to a mobile terminal for receiving Digital Multimedia Broadcasting (DMB), and in particular, to an apparatus and method for additionally storing relation information on stored contents in channel information when receiving and storing DMB.

2. Description of the Related Art

In recent years, mobile terminals such as mobile communication terminals and Personal Digital Assistants (PDAs) have been widely used. The mobile terminal's utility has significantly increased in scope, considering the increased terminal functions such as photographing an image or a moving picture by a digital camera, viewing Digital Multimedia Broadcasting (DMB), editing a document, playing a game, navigating and transmitting/receiving a short message and a multimedia message attached with a photographed image or moving picture, as well as simple telephony or schedule management.

DMB is a broadcasting service for sending broadcasting contents and allowing subscribers who may be in motion to view or listen to various multimedia broadcasts such as video, audio and data outdoors by a multi channel, using a personal portable or vehicle receiver equipped with a reception antenna.

A conventional mobile terminal can store corresponding contents associated with only a storable channel or broadcast in a DMB channel that is on the air. The conventional mobile terminal can separately manage a list of the stored contents and can reproduce and preview contents in the list. As such, the conventional mobile terminal can reproduce and preview contents. However, the conventional mobile terminal causes an inconvenience that user has to find out and memorize or take a separate memo of information on a corresponding channel and broadcast for preservation when he/she desires to know channel information on corresponding contents or view or record a next edition of a stored series broadcast of a corresponding channel.

A mobile terminal having a DMB reception function receives Code Division Multiplexing (CDM) channel information related to a DMB service from a satellite. Electronic Program Guide (EPG) information is included in several pieces of received information and is related to broadcast. Because each table of the EPG information is continuously retransmitted at a constant period, a user can receive the EPG information though he/she uses the DMB service anytime.

FIG. 1 illustrates a portion of channel information according to a conventional art. A table of EPG information will be described with reference to FIG. 1. EPG 100 includes a Broadcaster Information Table (BIT) 101, a Service Description Table (SDT) 103, an Event Information Table (EIT) 105 and a Time Offset Table (TOT) 107. The BIT 101 is used to transmit broadcaster information. The BIT 101 transmits a public service notice, a broadcaster name and current channel lists. A broadcast IDentifier (ID) is used to distinguish different BITs 101. The SDT 103 is used to transmit information on each channel. The channel information has a channel name, channel Uniform Resource Locator (URL) information, channel charge or free information and channel type information (indicating whether a channel is a recordable or non-recordable video or audio channel). The SDT 103 distinguishes different SDTs using a service ID. The EIT 105 represents genre information on each program. The EIT 105 is used to transmit a program name, program URL information, a program start time, a time taken to start and end program and admission rating and transmit genre information on a corresponding program. The EIT 105 uses an event ID to distinguish different events. The TOT 107 represents current time information, and is required when it is compared whether any program is now in execution or when a current time is displayed. As such, the user can know various DMB channel information by the EPG information in real time.

Thus, in order to solve the above drawbacks, an apparatus and method are needed for storing corresponding channel information and broadcast information together when storing a DMB, and for easily finding out corresponding information and performing a function related to the corresponding information when needing relation information on later stored contents.

### SUMMARY OF THE INVENTION

An aspect of the present invention is to substantially solve at least the above problems and/or disadvantages and to provide at least the advantages below. Accordingly, an aspect of the present invention is to provide an apparatus and method for additionally storing relation information when storing DMB contents in a mobile terminal receiving DMB.

Another aspect of the present invention is to provide an apparatus and method for, upon receipt of a request for outputting relation information on stored contents, searching and outputting the contents relation information in a mobile terminal.

A further aspect of the present invention is to provide an apparatus and method for making reservations for storing series contents related to stored contents in a mobile terminal.

According to the present invention, there is provided a method for storing DMB in a mobile terminal. The method includes, upon receipt of a request for storing contents, searching received channel information for contents relation information, and storing the contents and the searched contents relation information.

According to the present invention, there is provided an apparatus for storing DMB in a mobile terminal. The apparatus includes a DMB receiver for receiving DMB contents and channel information, a memory for storing the DMB contents and contents relation information, and a controller for, upon receipt of a request for storing the contents, controlling and searching the channel information received through the DMB receiver for the contents relation information, which is relation information on the contents, and storing the contents and the searched contents relation information in the memory.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a portion of channel information according to a conventional art;

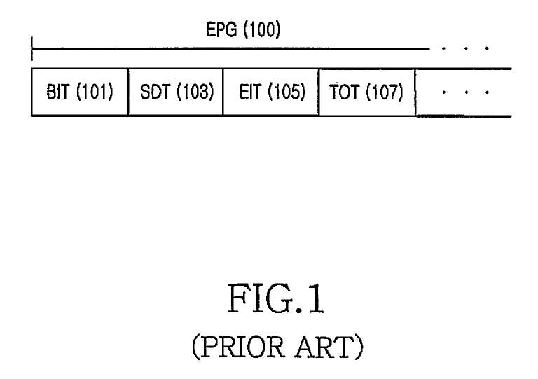

FIG. 2 illustrates the construction of a mobile terminal storing DMB according to the present invention;

FIG. 3 illustrates a procedure of storing DMB in the mobile terminal according to the present invention;

FIG. 4 illustrates a procedure of outputting relation information on contents of stored DMB in the mobile terminal according to the present invention;

FIG. 5 illustrates a procedure of searching and reservation storing contents related to contents of stored DMB in the mobile terminal according to the present invention; and

FIGS. 6A to 6C illustrate display screens for a list of stored DMB contents, relation information on the stored contents, and reservation for storage in the mobile terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

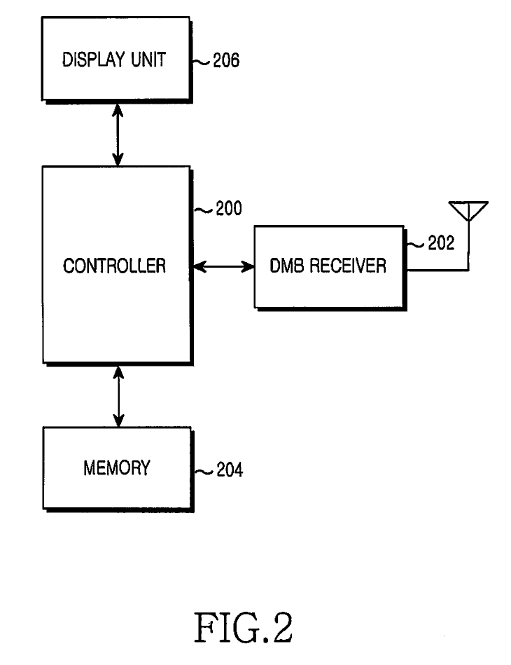

FIG. 2 illustrates the construction of a mobile terminal storing DMB according to the present invention. Referring to FIG. 2, the mobile terminal includes a controller 200, a DMB receiver 202, a memory 204, and a display unit 206.

The DMB receiver 202 receives broadcasting contents data and channel information under the control of the controller 200. The memory 204 stores contents data and contents relation information under the control of the controller 200.

The contents relation information stored in the memory 204 includes a channel name, channel URL information, channel charge or free information, channel type information (information on whether a channel is a recordable or non-recordable video or audio channel), genre information, a contents name, contents URL information and information such as a contents start time, a contents execution time and admission rating.

The display unit 206 outputs stored contents data and relation information on stored contents under the control of the controller 200.

If receiving a request for storing contents, the controller 200 controls and identifies relation information on contents to be stored in channel information, which is received through the DMB receiver 202, and stores contents data and contents relation information in the memory 204.

If receiving a request for outputting relation information on stored contents, the controller 200 searches the memory 204 for the contents relation information and outputs the searched contents relation information to the display unit 206.

If receiving a request for making reservations for storing contents related to stored contents (e.g., next broadcasting contents in a series broadcasting contents), the controller 200 controls and searches current channel information, which is received through the DMB receiver 202, for information related to the contents relation information, outputs a list of reservable relation contents to the display unit 206, and upon selection of contents to be reservation stored, registers to reservation store the selected contents.

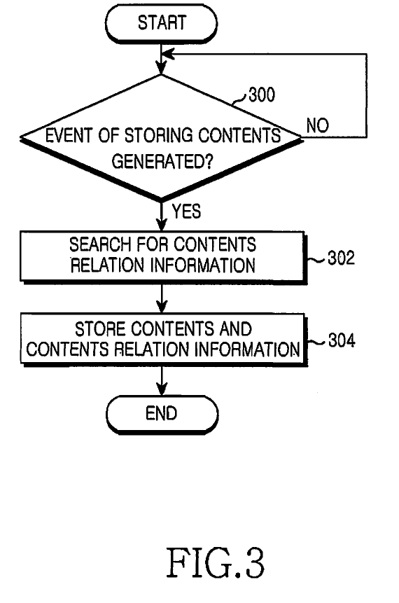

FIG. 3 illustrates a procedure of storing DMB in the mobile terminal according to the present invention.

Referring to FIG. 3, the mobile terminal checks whether it detects an event of storing DMB contents in Step 300. If so, in Step 302, the mobile terminal searches received channel information for contents relation information, which is relation information on contents to be stored. In Step 304, the mobile terminal stores the contents and the contents relation information.

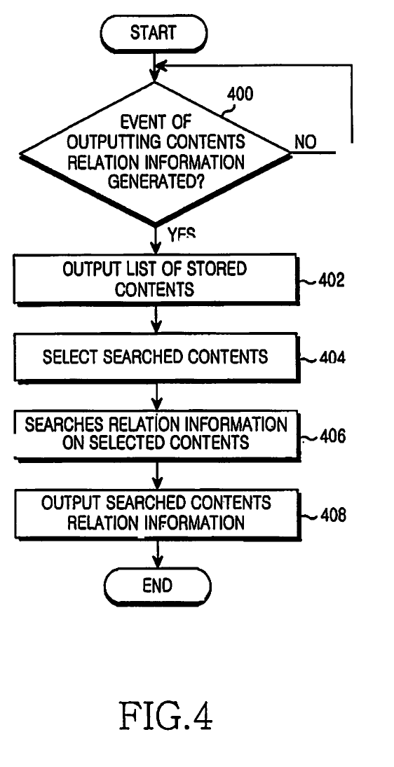

FIG. 4 illustrates a procedure of outputting relation information on contents of a stored DMB in the mobile terminal according to the present invention.

Referring to FIG. 4, the mobile terminal checks whether it detects an output event of relation information on stored contents in Step 400. If so, the mobile terminal outputs a list of the stored contents in Step 402. In Step 404, the mobile terminal selects contents for which relation information is to be outputted. In Step 406, the mobile terminal searches the memory for relation information on the selected contents. In Step 408, the mobile terminal outputs the searched contents relation information.

When an event of outputting relation information on stored contents is generated while the stored contents are reproduced, the Steps 402 to 404 are omitted. In the Step 406, relation information on reproduced contents is searched.

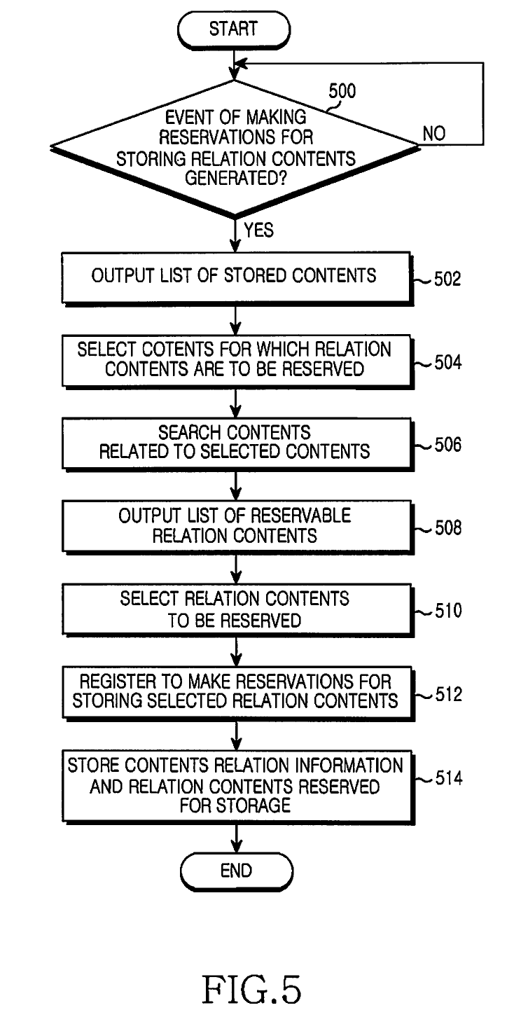

FIG. 5 illustrates a procedure of searching and reservation storing contents related to contents of stored DMB in the mobile terminal according to the present invention.

Referring to FIG. 5, the mobile terminal checks whether it detects an event of making reservations for storing contents related to stored contents in Step 500. If not, the mobile terminal repeats this step. If so, the mobile terminal outputs a list of the stored contents in Step 502. In Step 504, the mobile terminal selects contents for which relation contents are to be reserved from the stored contents. In Step 506, the mobile terminal searches the memory for relation information on the selected contents and searches current received channel information for information on contents, which can be reserved for storage, related to the contents relation information. In Step 508, the mobile terminal outputs a list of the relation contents that can be reserved for storage. In Step 510, the mobile terminal selects the relation contents to be reserved for storage. In Step 512, the mobile terminal registers to make reservations for storing the selected relation contents. In Step 514, the mobile terminal stores the reserved relation contents together with the contents relation information depending on a reservation condition.

When an event of making reservations for storing the relation contents is generated while the stored contents are reproduced, the Steps 502 to 504 are omitted. In the Step 506, contents related to the reproduced contents are searched.

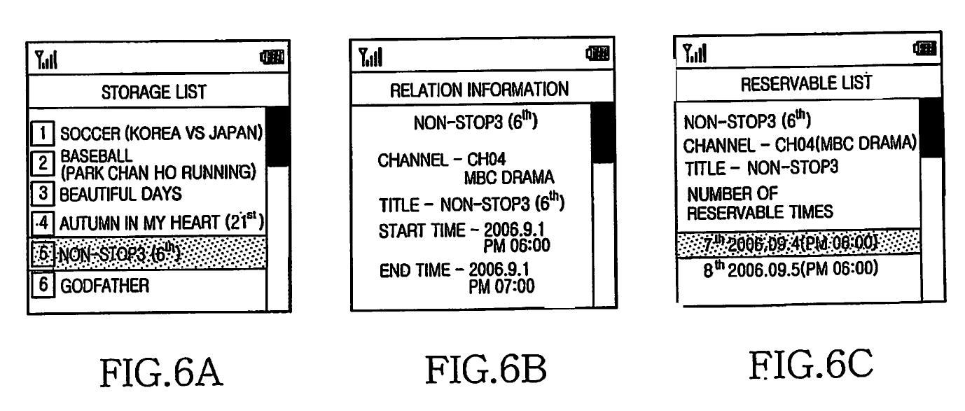

FIGS. 6A to 6C illustrate the display screens for a list of stored DMB contents, relation information on the stored contents, and reservation for storage in the mobile terminal according to the present invention.

FIG. 6A is a display screen of a list of contents stored in the mobile terminal. FIG. 6B is a display screen of relation information on “Non-stop3 (6^{th})” that is fifth item of the stored contents. FIG. 6C is a display screen of a list of reservable relation contents of “Non-stop3 (6^{th})” that is the fifth item of the stored contents.

As described above, the present invention provides the apparatus and method for additionally storing relation information on stored contents the channel information when receiving and storing DMB in the mobile terminal receiving DMB. The present invention provides relation information on stored contents and makes reservations for storing relation contents.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDS), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for storing Digital Multimedia Broadcasting (DMB) in a mobile terminal, the method comprising:
searching, upon receipt of a request for storing contents, received channel information for contents relation information that is related to the contents; and
storing the contents and the searched contents relation information.

2. The method of claim 1, wherein the contents relation information includes at least one of a channel name, channel Uniform Resource Locator (URL) information, channel charge or free information, channel type information indicating whether a channel is a recordable or non-recordable video channel or audio channel, genre information, a contents name, contents URL information, a contents start time, a contents execution time and an admission rating.

3. The method of claim 2, further comprising searching and outputting the stored contents relation information when receiving a request for outputting information on the contents, after the storing of the contents and the searched contents relation information.

4. The method of claim 2, further comprising, after the storing of the contents and the searched contents relation information,
searching received current channel information for the relation contents using the stored contents relation information, if a request for making reservations for storing relation contents related to the contents is received;
outputting a list of the relation contents reservable for storage as the search result;
selecting the relation contents to be reserved from the list of the relation contents; and
registering to make reservations for storing the selected relation contents.

5. An apparatus for storing Digital Multimedia Broadcasting (DMB) in a mobile terminal, the apparatus comprising:
a DMB receiver for receiving DMB contents and channel information;
a memory for storing the DMB contents and contents relation information; and
a controller for, upon receipt of a request for storing the contents, controlling and searching the channel information received through the DMB receiver for the contents relation information, and storing the contents and the searched contents relation information in the memory.

6. The apparatus of claim 5, wherein the contents relation information searched by the controller includes at least one of a channel name, channel Uniform Resource Locator (IRL) information, channel charge or free information, channel type information indicating whether a channel is a recordable or non-recordable video channel or audio channel, genre information, a contents name, contents URL information, a contents start time, a contents execution time and an admission rating.

7. The apparatus of claim 6, wherein after storing the contents and the searched contents relation information, the controller controls, searches and outputs the stored contents relation information if the controller receives a request for outputting information on the contents.

8. The apparatus of claim 6, wherein after storing the contents and the searched contents relation information, the controller controls and searches the channel information received through the DMB receiver for the relation contents using the stored contents relation information, outputs a list of the relation contents reservable for storage, selects the relation contents to be reserved from a list of the relation contents, and registers to make reservations for storage, if the controller receives a request for making reservations for storing relation contents related to the contents.

9. An apparatus for storing Digital Multimedia Broadcasting (DMB) in a mobile terminal, the apparatus comprising:
means for searching, received channel information for contents relation information that is related to the contents; and
means for storing the contents and the searched contents relation information.

10. The apparatus of claim 9, wherein the contents relation information includes at least one of a channel name, channel Uniform Resource Locator (URL) information, channel charge or free information, channel type information indicating whether a channel is a recordable or non-recordable video channel or audio channel, genre information, a contents name, contents URL information, a contents start time, a contents execution time and an admission rating.

11. The apparatus of claim 10, further comprising means for searching and outputting the stored contents relation information.

12. The apparatus of claim 10, further comprising, after the storing of the contents and the searched contents relation information, means for searching received current channel information for the relation contents using the stored contents relation information;
means for outputting a list of the relation contents reservable for storage as the search result;
means for selecting the relation contents to be reserved from the list of the relation contents; and
means for registering to make reservations for storing the selected relation contents.

13. A computer-readable recording medium having recorded thereon a program for storing Digital Multimedia Broadcasting (DMB) in a mobile terminal, comprising:
a first code segment, searching, upon receipt of a request for storing contents, received channel information for contents relation information that is related to the contents; and
a second code segment, storing the contents and the searched contents relation information.

14. The computer-readable recording medium of claim 13, wherein the contents relation information includes at least one of a channel name, channel Uniform Resource Locator (URL) information, channel charge or free information, channel type information indicating whether a channel is a recordable or non-recordable video channel or audio channel, genre information, a contents name, contents URL information, a contents start time, a contents execution time and an admission rating.

15. The computer-readable recording medium of claim 14, further comprising a third code segment, searching and outputting the stored contents relation information when receiving a request for outputting information on the contents.

16. The computer-readable recording medium of claim 14, further comprising,
a fourth code segment, searching received current channel information for the relation contents using the stored contents relation information;
a fifth code segment, outputting a list of the relation contents reservable for storage as the search result;
a sixth code segment, selecting the relation contents to be reserved from the list of the relation contents; and
a seventh code segment, registering to make reservations for storing the selected relation contents.
